(19) United States
(12) Patent Application Publication
(10) Pub. No.: US 2022/0319394 A1
(43) Pub. Date: Oct. 6, 2022

(54) DISPLAY DEVICE AND DRIVING METHOD THEREOF

(71) Applicant: TCL China Star Optoelectronics Technology Co., LTD., Shenzhen (CN)

(72) Inventor: Guangxing XIAO, Shenzhen (CN)

(21) Appl. No.: 16/640,742

(22) PCT Filed: Jan. 9, 2020
(86) PCT No.: PCT/CN2020/071095

§ 371 Date: Feb. 21, 2020

(30) Foreign Application Priority Data
Dec. 27, 2019 (CN) 201911372479.0

(51) Int. Cl. G09G 3/20

(52) U.S. Cl. CPC G09G 3/2096; G09G 2320/0673; G09G 2320/0276; G09G 2310/08; G09G 2330/021; G09G 2310/027

(57) ABSTRACT

A display device and a driving method thereof are provided. The display device includes a display panel, at least one source electrode driver connected to the display panel, a gamma register connected to the source electrode driver, a PMIC chip connected to the gamma register, and a timing controller. The timing controller comprises a video data rearrangement unit, a grayscale statistics unit connected to the video data rearrangement unit, a determination unit connected to the grayscale statistics unit, and a processing unit connected to the determination unit.

### FIELD OF INVENTION

The present invention relates to relates to a field of display driving technologies, especially relates to a display device and a driving method thereof.

### BACKGROUND OF INVENTION

Conventional full high definition (FHD) and ultra-high definition (UHD) display panel driver frameworks have some reload screen images. In a reload screen image, a data voltage frequently jumps between a high electrical level and a low electrical level. When a display brightness of constant several rows of sub-pixels switches frequently between a low brightness and a high brightness, a source electrode driver chip is under high load, and excessively high temperature generated therefrom easily damages the driver chip to cause malfunction and a great consumption of current to increase power consumption of the display panel. At present, the industries usually generate a heatsink on the driver chip to solve overheat issue of the driver chip. However, such means increases a cost and disadvantages mass production of the display panel. Therefore, it is necessary to set forth other solutions for solving the above issue.

### SUMMARY OF INVENTION

### Technical Issue

The embodiment of the present invention provides a display device and a driving method thereof to solve the technical issue that when a conventional display device display screen images, a reload screen image exists, a data voltage frequently jumps between a high electrical level and a low electrical level such that a source electrode driver chip is under high load to cause increased temperature of the driver chip to influence performance of the driver chip.

### Technical Solution

To solve the above issue, the present invention technical solutions are provided as follows:

An embodiment of the present invention provides a display device, comprising: a display panel, at least one source electrode driver connected to the display panel, a gamma register connected to the at least one source electrode driver, a power management integrated circuit (PMIC) chip connected to the gamma register, and a timing controller; wherein a first output terminal the timing controller is connected to the at least one source electrode driver, and a second output terminal of the timing controller is connected to the PMIC chip; wherein each of the at least one source electrode driver is connected to a plurality of data lines of the display panel, and each of the at least one source electrode driver controls driving data of a displaying region in which the data lines connected to the source electrode driver are located; wherein the timing controller comprises a video data rearrangement unit, a grayscale statistics unit connected to the video data rearrangement unit, a determination unit connected to the grayscale statistics unit, and a processing unit connected to the determination unit; wherein the video data rearrangement unit is configured to receive and re-arrange video data; wherein the grayscale statistics unit is configured to count, in a screen image of each frame, a number of grayscale in the displaying region controlled by each of the at least one source electrode driver and a frequency of high and low grayscale jump variation in the displaying region controlled by each of the at least one source electrode driver; wherein the determination unit is configured to determine whether a reload screen image exists in the video data; wherein the processing unit is configured to adjust a current screen image to a gamma voltage of the reload screen image; wherein the grayscale statistics unit comprising a grayscale histogram statistics unit and a frequency detecting unit; the grayscale histogram statistics unit is configured to count a number of grayscale, in a screen image of each frame, the displaying region controlled by each of the at least one source electrode driver; the frequency detecting unit is configured to count, in a screen image of each frame, a total number of high and low grayscale jump variation occurring in the displaying region controlled by each of the at least one source electrode driver; and wherein the at least one source electrode driver comprises a source electrode driver chip and a plurality of output wires, and the output wires are connected to the data lines respectively.

In at least one embodiment of the present invention, a third output terminal of the timing controller is connected to the gamma register.

In at least one embodiment of the present invention, a storage base is disposed in the PMIC chip, and the storage base is configured to store a gamma parameter for setting.

The embodiment of the present invention provides another a display device, comprising: a display panel, at least one source electrode driver connected to the display panel, a gamma register connected to the at least one source electrode driver, a power management integrated circuit (PMIC) chip connected to the gamma register, and a timing controller; wherein a first output terminal the timing controller is connected to the at least one source electrode driver, and a second output terminal of the timing controller is connected to the PMIC chip; wherein each of the at least one source electrode driver is connected to a plurality of data lines of the display panel, and each of the at least one source electrode driver controls driving data of a displaying region in which the data lines connected to the source electrode driver are located; wherein the timing controller comprises a video data rearrangement unit, a grayscale statistics unit connected to the video data rearrangement unit, a determination unit connected to the grayscale statistics unit, and a processing unit connected to the determination unit; wherein the video data rearrangement unit is configured to receive and re-arrange video data; wherein the grayscale statistics unit is configured to count, in a screen image of each frame, a number of grayscale in the displaying region controlled by each of the at least one source electrode driver and a frequency of high and low grayscale jump variation in the displaying region controlled by each of the at least one source electrode driver; wherein the determination unit is configured to determine whether a reload screen image exists in the video data; and wherein the processing unit is configured to adjust a current screen image to a gamma voltage of the reload screen image.

In at least one embodiment of the present invention, the grayscale statistics unit comprising a grayscale histogram statistics unit and a frequency detecting unit; the grayscale histogram statistics unit is configured to count a number of grayscale, in a screen image of each frame, the displaying region controlled by each of the at least one source electrode driver; the frequency detecting unit is configured to count, in a screen image of each frame, a total number of high and low grayscale jump variation occurring in the displaying region controlled by each of the at least one source electrode driver.

In at least one embodiment of the present invention, a third output terminal of the timing controller is connected to the gamma register.

In at least one embodiment of the present invention, a storage base is disposed in the PMIC chip, and the storage base is configured to store a gamma parameter for setting.

In at least one embodiment of the present invention, the at least one source electrode driver comprises a source electrode driver chip and a plurality of output wires, and the output wires are connected to the data lines respectively.

The present invention also provides a display device driving method, comprising:

a step S10, receiving and re-arranging video data;

a step S20, counting, in a screen image of each frame, a grayscale histogram in a displaying region controlled by each of the at least one source electrode driver and a frequency of high and low grayscale jump variation in the displaying region controlled by each of the at least one source electrode driver;

a step S30, determining whether a reload screen image exists in the video data, if yes, implementing a step S40, if not, implementing a step S50;

the step S40, adjusting a gamma voltage corresponding to the reload screen image; and

the step S50, outputting the gamma voltage to the at least one source electrode driver.

In at least one embodiment of the present invention, in the step S20, a method for counting the grayscale histogram comprises: counting, in the screen image of each frame, a number of grayscale in the displaying region controlled by each of the at least one source electrode driver.

In at least one embodiment of the present invention, in the step S20, a method for counting a frequency of high and low grayscale jump variation occurring on data lines comprises:

counting a number of high and low grayscale jump variation occurring on each of the data lines in the displaying region controlled by each of the at least one source electrode driver in the screen image of each frame; and

summing the numbers of high and low grayscale jump variation occurring on the data lines of each of the at least one source electrode driver in the screen image of each frame to acquire the total number of the high and low grayscale jump variation occurring in the displaying region controlled by each of the at least one source electrode driver.

In at least one embodiment of the present invention, in the step S30, a method for determining whether the reload screen image exists in the video data comprises:

sequentially determining, in the screen image of each frame, whether the total number of the high and low grayscale jump variation occurring in the displaying region controlled by each of the at least one source electrode driver exceeds a predetermined value; and

in a screen image of a frame, if it is satisfied that the total number of the high and low grayscale jump variation occurring in the displaying region controlled by each of the at least one source electrode driver exceeds the predetermined value, determining that the displaying region controlled by the at least one source electrode driver as a heavy load region and determining the screen image as a reload screen image;

if not satisfied, determining the screen image as a light load region.

In at least one embodiment of the present invention, the step S40 comprises:

acquiring a driving data of the heavy load region according to the grayscale histogram corresponding to the heavy load region; and

re-configuring a gamma register according to the driving data of the heavy load region to change a gamma voltage outputted by the gamma register.

### Advantages

By increasing the video data rearrangement unit and the grayscale statistics unit in an internal framework of the timing controller, re-arranging video data, and detecting data lines the occurring frequency of high and low grayscale jump variation of the data lines driven by different source electrode drivers, existence or absence of a reload screen image in the displaying region corresponding to each of the source electrode drivers such that a gamma voltage of the reload screen image is changed to further lower the temperature of the source electrode driver chip.

### DESCRIPTION OF DRAWINGS

To more clearly elaborate on the technical solutions of embodiments of the present invention or prior art, appended figures necessary for describing the embodiments of the present invention or prior art will be briefly introduced as follows. Apparently, the following appended figures are merely some embodiments of the present invention. A person of ordinary skill in the art may acquire other figures according to the appended figures without any creative effort.

FIG. 1 is a block diagram of a display device provided by the embodiment of the present invention; and

FIG. 2 is a flowchart of a display device driving method provided by the embodiment of the present invention.

### DETAILED DESCRIPTION OF PREFERRED EMBODIMENTS

The technical solution in the embodiment of the present invention will be clearly and completely described below with reference to the accompanying drawings in the embodiments of the present invention. Apparently, the described embodiments are merely some embodiments of the present invention instead of all embodiments. According to the embodiments in the present invention, all other embodiments obtained by those skilled in the art without making any creative effort shall fall within the protection scope of the present invention.

In the description of the present invention, it should be understood that terminologies “center”, “longitudinal”, “transverse”, “length”, “width”, “thickness”, “upper”, “lower”, “front”, “rear”, “left”, “side”, “vertical”, “horizontal”, “top”, “bottom”, “inner”, “outer”, “clockwise”, “counterclockwise” for indicating relations of orientation or position are based on orientation or position of the accompanying drawings, are only for the purposes of facilitating description of the present invention and simplifying the description instead of indicating or implying that the referred device or element must have a specific orientation or position, must to be structured and operated with the specific orientation or position. Therefore, they should not be understood as limitations to the present invention. Furthermore, terminologies “first”, “second” are only for the purposes of description, and cannot be understood as indication or implication of comparative importance or a number of technical features. Therefore, a feature limited with “first”, “second” can expressly or implicitly include one or more features. In the description of the present invention, a meaning of “a plurality of” is two or more, unless there is a clear and specific limitation otherwise.

In the description of the present invention, it should be noted that unless clear rules and limitations otherwise exist, terminologies “install”, “connect”, “connection” should be understood in a broad sense. For instance, the connection can be a fixed connection, a detachable connection or an integral connection. The connection can be a mechanical connection, an electrical connection or a telecommunication. The connection can be a direct connection, an indirect connection through an intermedium, can be an internal communication between two elements or an interaction between the two elements. For a person of ordinary skill in the art, the specific meaning of the above terminology in the present invention can be understood on a case-by-case basis.

In the present invention, it should be noted that unless clear rules and limitations otherwise exist, words “a first feature is “on” or “under” a second feature” can include a direct contact of the first and second features, can also include a contact of the first and second features through another feature therebetween instead of a direct contact. Furthermore, words “the first feature is “above” or “over” the second feature include that the first feature is right above or obliquely above the second feature, or only indicate that a level of the first feature is higher that of the second feature. Words “the first feature is “under” or “below” the second feature include that the first feature is right under or obliquely under the second feature, or only indicate that the level of the first feature is lower than that of the second feature.

The following disclosure provides many different embodiments or examples to achieve different structures of the present invention. To simplify the disclosure of the present invention, the components and arrangements of the specific examples are described below. Of course, they are merely examples, and the purpose is not to limit the present invention. Furthermore, the present invention may repeat reference numerals and/or reference letters in different examples. The repetition is for the purpose of simplification and clarity, and does not by itself indicate the relationship between the various embodiments and/or settings discussed. In addition, the present invention provides examples of various specific processes and materials, but a person of ordinary skill in the art can be aware of the application of other processes and/or the use of other materials.

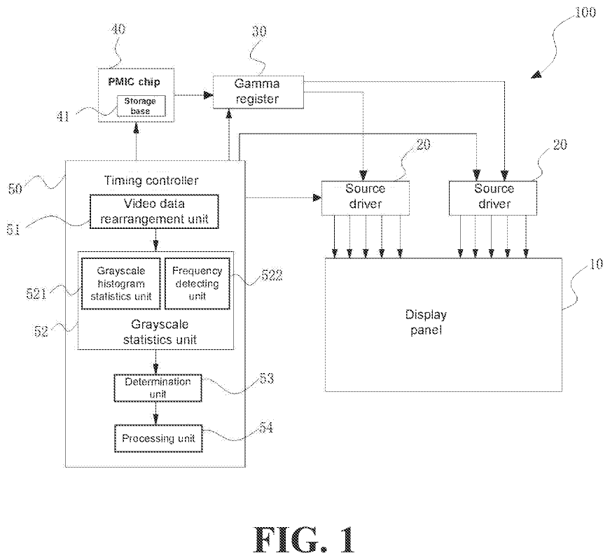

With reference to FIG. 1, the embodiment of the present invention provides a display device 100, the display device 100 comprises a display panel 10, at least one source electrode driver 20, a gamma register 30, a power management integrated circuit (PMIC) chip 40, and a timing controller 50.

FIG. 1 takes two source electrode drivers 20 as an exemplary explanation but is not limited thereto. The source electrode drivers 20 are connected to the display panel 10, and each of the source electrode drivers 20 is connected to a plurality of data lines of the display panel 10, each of the source electrode drivers 20 is configured to input a data voltage to data lines of the display panel 10. In other words, each of the source electrode drivers 20 controls driving data of a displaying region where the data lines connected the source electrode driver are located, to achieve charging of sub-pixels in the displaying region.

The source electrode driver 20 is connected to the gamma register 30. The gamma register 30 is stored with relationships of brightness and grayscale of graphic contained by all of corresponding grayscale points. The gamma register 30 is configured to output a gamma voltage to the source electrode driver 20.

The PMIC chip 40 is connected to the gamma register 30, and the PMIC chip is configured to provide a power. one gamma register 30 is disposed between the PMIC chip 40 and the gamma register 30 and can control an amount of the voltage outputted by the PMIC chip 40 to the source electrode driver 20, implement gamma calibration to the driving voltage on the display panel 10 to optimize the brightness of display.

The first output terminal of the timing controller 50 is connected to the PMIC chip 40, the second output terminal of the timing controller is connected to the source electrode driver 20, the timing controller 50 is configured to transfer a voltage control signal to the PMIC chip 40, the timing controller 50 is configured to transfer a driving control signal to the at least one source electrode driver.

Because a conventional high resolution display device have some reload screen images and result in the source electrode driver in a high load working environment, and excessively high temperature generated by the source electrode driver easily damages the driver chip. The embodiment of the present invention, by improving an internal framework of the timing controller, enables the timing controller to determine existence of the reload screen image in a video data and adjust a corresponding gamma voltage to lower the temperature of the source electrode driver.

Specifically, the timing controller 50 in the embodiment of the present invention comprises a video data rearrangement unit 51, a grayscale statistics unit 52 connected to the video data rearrangement unit 51, a determination unit 53 connected to the grayscale statistics unit, and a processing unit 54 connected to the determination unit.

The video data rearrangement unit 51 is configured to receive and re-arrange video data.

The grayscale statistics unit 52 is configured to count, in a screen image of each frame, a number of grayscale in the displaying region controlled by each of the source electrode drivers 20 in a grayscale histogram and a frequency of high and low grayscale jump variation in the displaying region controlled by each of the source electrode drivers 20.

The determination unit 53 is configured to determine whether a reload screen image exists in the video data.

the processing unit 54 is configured to adjust a current screen image to a gamma voltage of the reload screen image.

Furthermore, the grayscale statistics unit 52 can comprise a grayscale histogram statistics unit 521 and a frequency detecting unit 522.

The grayscale histogram statistics unit 521 is configured to count a number of grayscale, in a screen image of each frame, the displaying region controlled by each of the source electrode drivers 20. In other words, a horizontal coordinate of the grayscale statistics histogram indicates a grayscale value, and a vertical coordinate thereof indicates a number of grayscale.

The frequency detecting unit 522 is configured to count, in a screen image of each frame, a total number of high and low grayscale jump variation occurring in the displaying region controlled by each of the source electrode drivers 20.

The determination unit 53, according to a grayscale display status of the displaying region controlled by each source electrode driver 20, determines whether a reload screen image exists in the video data.

The processing unit 54 can adjust the gamma voltage corresponding to the reload screen image by controlling an output voltage of the PMIC chip 40.

Specifically, the PMIC chip 40 can comprise a storage base (bank) 41 configured to store set gamma parameters. The storage base 41 is set with a set of gamma parameters that are a bank A and a bank B. The bank A and the bank B correspond to different ones of a high voltage and a low voltage. The storage base 41 comprises a first control pin and a second control pin. The first control pin corresponds to the bank A, and the second control pin corresponds to the bank B. Connection of the gamma register 30 with first control pin or the second control pin can be switched to change the gamma voltage outputted by the gamma register 30.

In other embodiment, a third output terminal of the timing controller can be connected to the gamma register 30. The timing controller can be disposed with the gamma register 30 in real time to change the gamma voltage outputted by the gamma register 30.

The source electrode driver comprises a source electrode driver chip and a plurality of output wires. Each of the output wires corresponds to one of the output terminals of the source electrode driver. The output wires are connected to the data lines respectively.

The PMIC chip 40 is also connected to the display panel 10 and provide the display panel 10 with a power voltage.

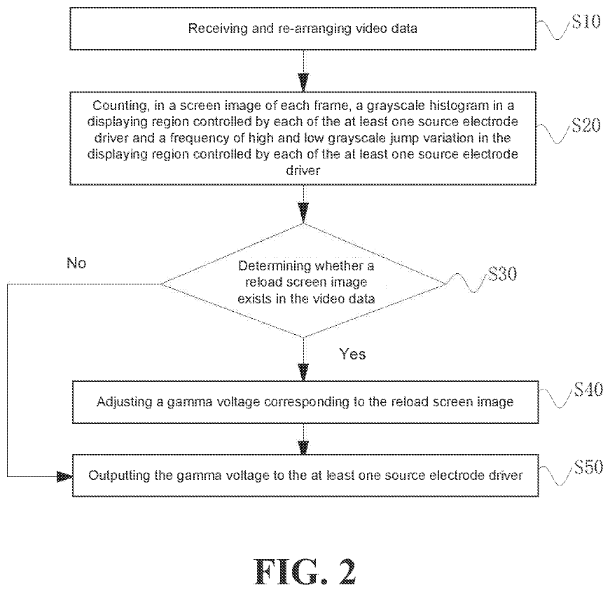

With reference to FIG. 2, a method for driving the display device 100 comprises: steps S10 to S40.

The step S10 comprises receiving and re-arranging video data;

The step S20 comprises counting, in a screen image of each frame, a grayscale histogram in a displaying region controlled by each of the at least one source electrode driver 20 and a frequency of high and low grayscale jump variation in the displaying region controlled by each of the at least one source electrode driver 20.

The step S30 comprises determining whether a reload screen image exists in the video data, if yes, implementing a step S40, if not, implementing a step S50.

The step S40 comprises adjusting a gamma voltage corresponding to the reload screen image.

The step S50, outputting the gamma voltage to the at least one source electrode driver.

Because different frameworks of the display panel have different driving methods, for example, 1G1D framework, dual-gate electrode framework, triple-gate electrode framework, the video data should be re-arranged based on the different frameworks of the display panel.

The video data is re-arranged automatically by the video data rearrangement unit, data is re-arranged based on display data of each of the data lines such that a number the high and low grayscale jump variation occurring on each of the data lines in a screen image of each frame can be counted.

In the step S20, the grayscale histogram statistics can be completed by the grayscale histogram statistics unit 521. The grayscale histogram statistics unit 521, by receiving re-arranged video data and counting a number of grayscale in the displaying region controlled by each source electrode driver 20, locks a position where the high and low grayscale jump variation occurs.

In the step S20, statistics of the frequency of high and low grayscale jump variation occurring on the data lines can be completed by the frequency detecting unit 522. First, a number of high and low grayscale jump variation occurring on each of the data lines in the displaying region controlled by each source electrode driver 20 in the screen image of each frame is counted. Second, the numbers of high and low grayscale jump variation occurring on the data lines of each source electrode driver 20 in the screen image of each frame are summed to acquire the total number of the high and low grayscale jump variation occurring in the displaying region controlled by each source electrode driver 20.

In the step S30, a method for determining whether the reload screen image exists in the video data comprises:

sequentially determining, in the screen image of each frame, whether the total number of the high and low grayscale jump variation occurring in the displaying region controlled by each source electrode driver 20 exceeds a predetermined value;

in a screen image of a frame, if it is satisfied that the total number of the high and low grayscale jump variation occurring in the displaying region controlled by each source electrode driver 20 exceeds the predetermined value, determining that the displaying region controlled by the source electrode driver 20 as a heavy load region and determining the screen image as a reload screen image; if not satisfied, determining the screen image as a light load region.

Because different frameworks of the display panel have different determining standards for high and low grayscale jump variation, it is required to set a specific standard based on real display panels. For example, when a data line jumps and varies from a current grayscale to a next grayscale, the jump variation should be determined as a high and low grayscale jump variation when a difference value of a driving voltage corresponding to the current grayscale and a driving voltage corresponding to the next grayscale exceeds a predetermined threshold. For example, a 8 bit display panel has a low grayscale being from 0 grayscale to 128 grayscale, and a high grayscale being from 129 grayscale to 255 grayscale. When a data line jumps and varies from a current grayscale to a next grayscale, the jump variation is determined as a high and low grayscale jump variation when the current grayscale and the next grayscale are different ones of a low grayscale and a high grayscale.

In a screen image of a frame, when a number of high and low grayscale jump variation occurring in the displaying region controlled by the source electrode driver 20 exceeds a predetermined value, a corresponding gamma voltage of the screen image is adjusted. When the number of high and low grayscale jump variation does not exceeds the predetermined value, a gamma voltage of the predetermined value is outputted. The predetermined value is a parameter value predetermined in the timing controller, and the predetermined value is necessarily defined with a specific framework of the display panel, and is not limited herein.

The gamma voltage outputted by the gamma register 30 can be adjusted by controlling the PMIC chip 40 through the processing unit 54 of the timing controller 50 to switch between the first control pin and the second control pin in the storage base 41.

Alternatively, the gamma register 30 is controlled in real time by the processing unit 54 of the timing controller 50 to change the gamma voltage.

A principle of the gamma register 30 controlled in real time by the processing unit 54 of the timing controller 50 comprises: driving data of the heavy load region is acquired according to the grayscale histogram corresponding to the heavy load region; the gamma register 30 is re-arranged according to the driving data of the heavy load region to change the gamma voltage outputted by the gamma register 30 such that the temperature of the source electrode driver 20 is lowered.

By increasing the video data rearrangement unit and the grayscale statistics unit in an internal framework of the timing controller, re-arranging video data, and detecting data lines the occurring frequency of high and low grayscale jump variation of the data lines driven by different source electrode drivers, existence or absence of a reload screen image in the displaying region corresponding to each of the source electrode drivers such that a gamma voltage of the reload screen image is changed to further lower the temperature of the source electrode driver chip.

In the above-mentioned embodiments, the descriptions of the various embodiments are focused. For the details of the embodiments not described, reference may be made to the related descriptions of the other embodiments.

The display device and the driving method provided by the embodiment of the present invention are introduced in detail as above. The principles and implementations of the present application are described in the following by using specific examples. The description of the above embodiments is only for assisting understanding of the technical solutions of the present application and the core ideas thereof. Those of ordinary skill in the art should understand that they can still modify the technical solutions described in the foregoing embodiments are or equivalently replace some of the technical features. These modifications or replacements do not depart from the essence of the technical solutions of the embodiments of the present application.

What is claimed is:

1. A display device, comprising:
a display panel, at least one source electrode driver connected to the display panel, a gamma register connected to the at least one source electrode driver, a power management integrated circuit (PMIC) chip connected to the gamma register, and a timing controller;
wherein a first output terminal the timing controller is connected to the at least one source electrode driver, and a second output terminal of the timing controller is connected to the PMIC chip;
wherein each of the at least one source electrode driver is connected to a plurality of data lines of the display panel, and each of the at least one source electrode driver controls driving data of a displaying region in which the data lines connected to the source electrode driver are located;
wherein the timing controller comprises a video data rearrangement unit, a grayscale statistics unit connected to the video data rearrangement unit, a determination unit connected to the grayscale statistics unit, and a processing unit connected to the determination unit;
wherein the video data rearrangement unit is configured to receive and re-arrange video data;
wherein the grayscale statistics unit is configured to count, in a screen image of each frame, a number of grayscale in the displaying region controlled by each of the at least one source electrode driver and a frequency of high and low grayscale jump variation in the displaying region controlled by each of the at least one source electrode driver;
wherein the determination unit is configured to determine whether a reload screen image exists in the video data;
wherein the processing unit is configured to adjust a current screen image to a gamma voltage of the reload screen image;
wherein the grayscale statistics unit comprising a grayscale histogram statistics unit and a frequency detecting unit; the grayscale histogram statistics unit is configured to count a number of grayscale, in a screen image of each frame, the displaying region controlled by each of the at least one source electrode driver; the frequency detecting unit is configured to count, in a screen image of each frame, a total number of high and low grayscale jump variation occurring in the displaying region controlled by each of the at least one source electrode driver; and
wherein the at least one source electrode driver comprises a source electrode driver chip and a plurality of output wires, and the output wires are connected to the data lines respectively.

2. The display device as claimed in claim 1, wherein a third output terminal of the timing controller is connected to the gamma register.

3. The display device as claimed in claim 1, wherein a storage base is disposed in the PMIC chip, and the storage base is configured to store a gamma parameter for setting.

4. A display device, comprising:
a display panel, at least one source electrode driver connected to the display panel, a gamma register connected to the at least one source electrode driver, a power management integrated circuit (PMIC) chip connected to the gamma register, and a timing controller;
wherein a first output terminal the timing controller is connected to the at least one source electrode driver, and a second output terminal of the timing controller is connected to the PMIC chip;
wherein each of the at least one source electrode driver is connected to a plurality of data lines of the display panel, and each of the at least one source electrode driver controls driving data of a displaying region in which the data lines connected to the source electrode driver are located;
wherein the timing controller comprises a video data rearrangement unit, a grayscale statistics unit connected to the video data rearrangement unit, a determination unit connected to the grayscale statistics unit, and a processing unit connected to the determination unit;
wherein the video data rearrangement unit is configured to receive and re-arrange video data;
wherein the grayscale statistics unit is configured to count, in a screen image of each frame, a number of grayscale in the displaying region controlled by each of the at least one source electrode driver and a frequency of high and low grayscale jump variation in the displaying region controlled by each of the at least one source electrode driver;
wherein the determination unit is configured to determine whether a reload screen image exists in the video data; and
wherein the processing unit is configured to adjust a current screen image to a gamma voltage of the reload screen image.

5. The display device as claimed in claim 4, wherein the grayscale statistics unit comprising a grayscale histogram statistics unit and a frequency detecting unit; the grayscale histogram statistics unit is configured to count a number of grayscale, in a screen image of each frame, the displaying region controlled by each of the at least one source electrode driver; the frequency detecting unit is configured to count, in a screen image of each frame, a total number of high and low grayscale jump variation occurring in the displaying region controlled by each of the at least one source electrode driver.

6. The display device as claimed in claim 4, wherein a third output terminal of the timing controller is connected to the gamma register.

7. The display device as claimed in claim 4, wherein a storage base is disposed in the PMIC chip, and the storage base is configured to store a gamma parameter for setting.

8. The display device as claimed in claim 4, wherein the at least one source electrode driver comprises a source electrode driver chip and a plurality of output wires, and the output wires are connected to the data lines respectively.

9. A display device driving method, comprising:
a step S10, receiving and re-arranging video data;
a step S20, counting, in a screen image of each frame, a grayscale histogram in a displaying region controlled by each of the at least one source electrode driver and a frequency of high and low grayscale jump variation in the displaying region controlled by each of the at least one source electrode driver;
a step S30, determining whether a reload screen image exists in the video data, if yes, implementing a step S40, if not, implementing a step S50;
the step S40, adjusting a gamma voltage corresponding to the reload screen image; and
the step S50, outputting the gamma voltage to the at least one source electrode driver.

10. The display device driving method as claimed in claim 9, wherein in the step S20, a method for counting the grayscale histogram comprises:
counting, in the screen image of each frame, a number of grayscale in the displaying region controlled by each of the at least one source electrode driver.

11. The display device driving method as claimed in claim 10, wherein in the step S20, a method for counting a frequency of high and low grayscale jump variation occurring on data lines comprises:
counting a number of high and low grayscale jump variation occurring on each of the data lines in the displaying region controlled by each of the at least one source electrode driver in the screen image of each frame; and
summing the numbers of high and low grayscale jump variation occurring on the data lines of each of the at least one source electrode driver in the screen image of each frame to acquire the total number of the high and low grayscale jump variation occurring in the displaying region controlled by each of the at least one source electrode driver.

12. The display device driving method as claimed in claim 11, wherein in the step S30, a method for determining whether the reload screen image exists in the video data comprises:
sequentially determining, in the screen image of each frame, whether the total number of the high and low grayscale jump variation occurring in the displaying region controlled by each of the at least one source electrode driver exceeds a predetermined value; and
in a screen image of a frame, if it is satisfied that the total number of the high and low grayscale jump variation occurring in the displaying region controlled by each of the at least one source electrode driver exceeds the predetermined value, determining that the displaying region controlled by the at least one source electrode driver as a heavy load region and determining the screen image as a reload screen image;
if not satisfied, determining the screen image as a light load region.

13. The display device driving method as claimed in claim 12, wherein the step S40 comprises:
acquiring a driving data of the heavy load region according to the grayscale histogram corresponding to the heavy load region; and
re-configuring a gamma register according to the driving data of the heavy load region to change a gamma voltage outputted by the gamma register.
